(19) United States
(12) Patent Application Publication
(10) Pub. No.: US 2008/0265008 A1
(43) Pub. Date: Oct. 30, 2008

(54) Two Piece Carton

(76) Inventor: John M. Holley, Lawrenceville, GA (US)

Correspondence Address: MEADWESTVACO CORPORATION;LAW DEPARTMENT, 1021 Main Campus Dr., Raleigh, NC, 27606, US

(21) Appl. No.: 11/573,223

(22) PCT Filed: Aug. 4, 2005
(86) PCT No.: PCT/US05/27621

§ 371 Date: Aug. 21, 2007

Related U.S. Application Data
(60) Provisional application No. 60/598,873, filed on Aug. 4, 2004.

(51) Int. Cl. B65D 5/42; B65D 5/46; B31B 1/86

(52) U.S. Cl. 229/117.14; 229/109; 493/88

(57) ABSTRACT

A carton may include a tray (110) with a pair of tray end panels (170, 180) and a pair of tray side panels (190, 200) and a lid (120) with a pair of lid end panels (370, 380) and a pair of lid side panels (390, 400). The tray end panels (170, 180) may have an adhesive thereon such that the lid end panels (370, 380) are attached to the tray end panels while the lid side panels (390, 400) are adjacent to but not attached to the tray side panels.

### TECHNICAL FIELD

The present invention relates generally to a carton for articles and more particularly relates to a two (2)-piece carton with at least one (1) reinforced handle.

### BACKGROUND OF THE INVENTION

Cartons for articles such as beverage containers and the like generally may be made out of cardboard, paperboard, corrugated board, or similar types of materials. The material generally is cut, folded, and then glued into the appropriate shape. The design of a carton thus may focus on minimizing the amount of material and adhesive used while maximizing the strength of the carton as a whole. Likewise, the carton preferably should be easy to assemble, load, and unload.

### SUMMARY OF THE INVENTION

The present invention thus may provide a carton. The carton may include a tray with a pair of tray end panels and a pair of tray side panels and a lid with a pair of lid end panels and a pair of lid end panels. The tray end panels may include an adhesive thereon such that the lid end panels are affixed to the tray end panels while the lid side panels are adjacent to but not attached to the tray side panels.

A first one of the first tray end panels may include a tray handle aperture while a first one of the lid end panels may include a lid handle aperture. The tray may include a tray base panel and the lid may include a lid top panel. The tray base panel may be octagonal in shape. The lid top panel may be rectangular in shape. Each tray side panel may be connected to a pair of beveled corner panels while each lid end panel may include a pair of beveled edges. At least one of the lid end panels may include a zipper thereon. Each tray side panel may be connected, either directly or indirectly, to a pair of reinforcing panels. The tray side panels may include a pair of tray flap thereon such that when the lid is placed on the tray, the tray flaps are positioned adjacent to the second tray side panels but not attached thereto.

The lid top panel may include a lid handle aperture therein. The lid handle aperture may define a handle cover panel. The lid also may include a handle panel. The lid handle panel may extend from one of the lid end panels to the other.

A further embodiment as described herein may provide a carton. The carton may include a tray with an end panel and a pair of first and second reinforcing panels. The end panel may include a first handle aperture. The first reinforcing panel may include a first handle cutout and the second reinforcing panel may include a second handle cutout. The first and the second reinforcing panels are disposed along one of the opposite surfaces of the end panel while the first and second handle cutouts may align with each other to form a second handle aperture. The carton also may include a lid. The lid may include a lid end panel with a third handle aperture. The lid is attached to the tray such that the lid end panel is disposed along one of the opposite surfaces of the end panel of the tray wherein the third handle aperture is aligned with the first and the second handle apertures.

The lid end panel may include a zipper cutout. The tray may include a pair of tray side panels with side panel flaps thereon. The lid may include a pair of lid side panels such that when the lid is positioned on the tray, the side panel flaps are positioned adjacent to but not attached to the lid side panels. The lid end panel may include a zipper thereon. The lid end panel may be fixedly attached to the tray about the zipper.

A further embodiment of the carton may include a first part and a removable second part. The first part may include a first panel with a first handle aperture and a reinforcing panel with at handle cutout. The second part may include a second panel with a second handle aperture. The second part is attached to the first part such that the second handle aperture is aligned with the first handle aperture and the handle cutout. The second panel of the second part may include a zipper thereon. The second part may be attached to the first part about the zipper.

A further embodiment of the carton may include a first part with a pair of first side panels and a pair of first end panels. The carton further includes a second part with a pair of second side panels, a pair of second end panels, and a handle cutout. The first end panels may include adhesive thereon so as to be secure d to the second end panels while the first side panels are positioned adjacent to but not attached to the second side panels. The second part may include a handle panel fixedly attached to the first part by the adhesive.

A method described herein may provide for constructing a carton with a tray and a lid. The method may include the steps of folding a tray blank such that a first panel with a first handle cutout is positioned adjacent to a pair of reinforcing panels with a second handle cutout, fixedly attaching the first panel to the reinforcing panel to form the tray, folding a lid blank with a first lid panel with a third handle cutout and a zipper to form the lid, positioning the lid on the tray such that the third handle cutout aligns with the first and second handle cutouts, and fixedly attaching the lid to the tray about the zipper.

These and other features of the present invention will become apparent upon review of the following detailed description when taken in conjunction with the drawings and the appended claims.

### BRIEF DESCRIPTION OF THE DRAWINGS

FIG. 1 is a plan view of a blank for assembling a tray or lower part of the carton of the invention.

FIG. 2 is a plan view of a blank for assembling a lid or upper part of the carton of the invention.

FIG. 3 is a perspective view of the carton formed from the blanks of FIGS. 1 and 2.

FIG. 4A is a perspective view of the carton of FIG. 3 in an opened condition.

FIG. 4B is a perspective view of the removed lid of the carton of FIG. 3.

FIG. 5 is a plan view of a blank for assembling a tray or lower part of the second embodiment of the carton of the invention.

FIG. 6 is a plan view of a blank used to assemble a lid or upper part of the second embodiment of the carton of the invention.

FIG. 7 is a perspective view of an assembled carton formed from the blanks of FIGS. 5 and 6.

### DETAILED DESCRIPTION

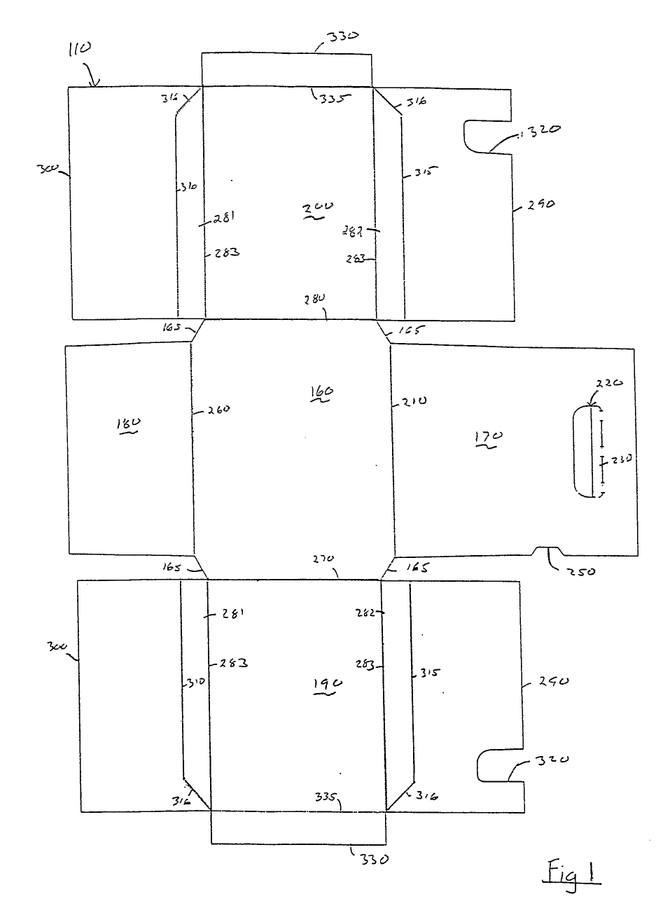

Referring now to the drawings, in which like numerals refer to like elements throughout the several view, FIGS. 1-4B show an embodiment of a carton 100 according to the present invention. The carton 100 may be a two (2)-piece container with a first or lower part 110 and a second or upper part 120. The first part 110 may be a tray or a similar type of open basket structure and the second part 120 may a lid or a similar type of covering structure and/or support structure.

The first part 110 and the second part 120 may be made out of cardboard, paperboard, corrugated board, plastic, or similar types of foldable sheet materials. Specifically, the first part 110 and the second part 120 may be made out of coated unbleached paperboard. The thickness of the material for the first part 110 and the second part 120 may be varied.

FIG. 1 shows a blank that may be used to assemble the first part 110, the tray. The blank may be cut in a die cutting process, a laser cutting process, or any other type of cutting method from a continuous sheet of foldable material.

The blank may have a number of fold lines and tear lines formed therein. The term fold line refers to a weakened line that facilitates folding of the material along the length of the weakened line. The fold line may include, but is not limited to, a score line, a perforation, a line of short slits, a line of half cuts, a combination of slits and score lines, and similar arrangements. Any reference to a fold line or any hinged connection should not be construed as being limited to a single fold line only. Any such fold line or hinged connection may be formed from one or more fold lines. The term tear line may refer to a line of severance or any other weakened line that facilitates separation along the length of the weakened line. The tear line may include, but is not limited to, a perforation, a line of short slits, a line of half cuts, a combination of slits and score lines, and similar arrangements.

The fold lines may define a number of panels. Specifically, a base panel 160, a first end panel 170, a second end panel 180, a first side panel 190, a second side panel 200, as well as number of corner panels and reinforcing panels as will be described in more detail below. The number of panels may be varied. Each of the panels may be largely rectangular in shape. Any desired shape or size, however, may be used. It will be recognized that ordering references, such as first and second, and directional references, such as top, base, bottom, side, upper, lower, etc., do not limit the structure described herein to such orientation, but merely serve to distinguish relative structure from one another.

The base panel 160 may have one or more beveled edges 165 such that the base panel 160 as a whole may have a pentagonal, hexagonal or other polygonal shape. In the embodiment of FIGS. 1-4B, the base panel 160 has four beveled edges 165 to be octagonal in shape. The beveled edge or edges 165 may accommodate the size and shape of the beverage containers, such as bottles, and as such provide a stable and tight carton 100 as a whole when loaded.

The first end panel 170 may be connected to the base panel 160 via a first base panel fold line 210. The first end panel 170 may have a handle aperture 220 positioned therein. The handle aperture 220 may have an extended oval shape. The handle aperture 220 may form a handle flap 230 that may be hingedly connected to the first end panel 170 to be folded inward for reinforcement. The first end panel 170 may also have a zipper cutout 250 positioned therein. The zipper cutout 250 may be an indention or notch on a side edge of the first end panel 170 to provide easy access to a zipper as will be described in more detail below.

The second end panel 180 may be hingedly connected to the base panel 160 via a second base panel fold line 260. When folded along the fold lines 210, 260, the first end panel 170 and the second end panel 180 may take respective positions where they are largely parallel to each other. Although the second end panel 180 is shown as being somewhat less in vertical length than the first end panel 170, any desired length may be used. Further, another handle aperture similar to the aperture 220 may be positioned within the second end panel 180 if desired.

The first side panel 190 may be hingedly connected to the base panel 160 via a third base panel fold line 270 and the second side panel 200 may be hingedly connected to the base panel 160 via a fourth base panel fold line 280. The first and second side panels 190, 200 may be largely identical to each other. When folded along the fold lines 270, 280, the first and second side panels 190, 200 also may take respective positions where they are largely parallel to each other and largely perpendicular to the first and the second end panels 170, 180.

The first and second side panels 190, 200 each also may be hingedly connected to a pair of corner panels. A first corner panel 281 and a second corner panel 282 are hingedly connected to each of the first and second side panels 190, 200. The corner panels 281, 282 may be bounded by, and connected to, the respective side panel along corner panel fold lines 283. The fold lines 283 may run the length of the corner panels 281, 282. The corner panels 281, 282 may be largely trapezoidal in shape. The corner panels 281, 282 may accommodate the beveled edges 165 of the base panel 160.

In turn, the corner panels 281, 282 also may be connected to reinforcing panels respectively. A first reinforcing panel 290 and a second reinforcing panel 300 are hingedly connected to the corner panels 282, 281 respectively. The reinforcing panel 290 may be connected to the corner panel 282 along fold lines 315, 316 while the reinforcing panel 300 may be connected to the corner panel 281 along fold lines 310, 316. The reinforcing panel fold lines 316, 316 are beveled to form the trapezoid shape of the corner panels 281, 282. When folded about the fold lines 310, 315, 316, the reinforcing panels 290, 300 may be positioned alongside either the inside or outside surfaces of the first and the second end panels 170, 180 respectively. The first reinforcing panels 290 each may have a cutout 320 that has a size about one-half of the handle aperture 220. The size of the handle cutout 320 on either reinforcing panel 290, as well as the relative width of each reinforcing panel 290, may be varied. When the reinforcing panels 290, 300 are folded, the handle cutouts 320 may in cooperation form a full aperture that is positioned to be aligned with the handle aperture 220 of the first end panel 170.

The first and second side panels 190, 200 each may have a reinforcing flap 330 hingedly connected thereto. Each flap 330 may extend entirely along the upper edge of the respective side panel. The flaps 330 may be hingedly connected to the first and the second side panels 190, 200 via tab fold lines 335 respectively.

To form the first or lower part 110, the side and end panels 170, 180, 190, 200 may be folded along the four (4) base panel fold lines 210, 260, 270, 280 to take respective positions where they are generally perpendicular to the base panel 160. The corner panels 281, 282 and the reinforcing panels 290, 300 may be folded along the corner panel fold lines 283 and the reinforcing flap fold lines 310, 315, 316 such that the reinforcing panels 290, 300 are disposed largely perpendicular to the side panels 190, 200 and are positioned behind or in front of the first and second panels 170, 180. The reinforcing panels 290, 300 may be attached to the first and second end panels 170, 180 by a conventional adhesive or otherwise.

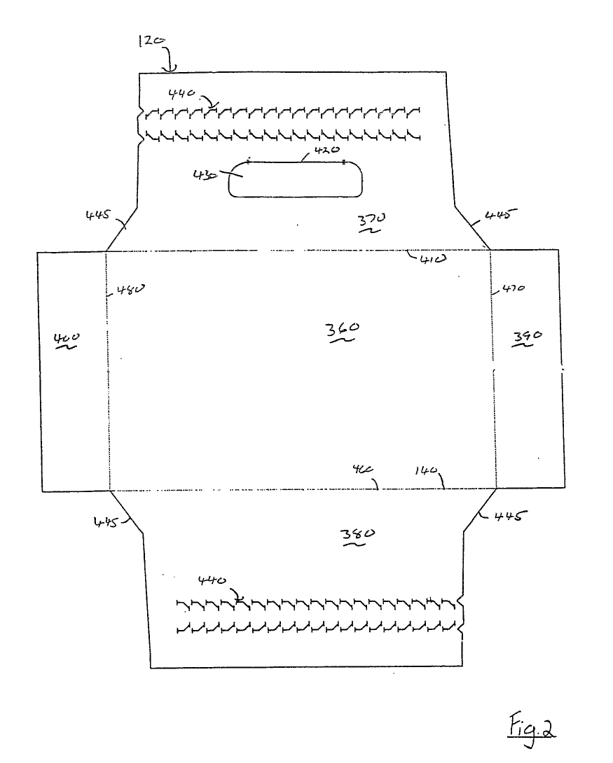

FIG. 2 shows a blank for the second (or upper) part 120 or the lid. As above, the blank 350 may have a number of fold lines and tear lines formed therein. The fold lines may define a number of panels. In this example, a top panel 360, a first end panel 370, a second end panel 380, a first side panel 390 and a second side panel 400. The number of panels may be varied. Each of the panels may be largely rectangular in shape. Any desired size or shape, however, may be used.

The first end panel 370 may be hingedly connected to the top panel 360 by a first top panel fold line 410. The first end panel 370 may have a handle aperture 420 formed therein. The handle aperture 420 may have a largely extended oval shape. The handle aperture 420 may define a handle flap 430. The handle flap 430 may be hingedly connected to the end panel 370 to be folded inward into the carton.

The first end panel 370 may have a zipper 440 formed therein. The term “zipper” as used herein refers to a number of tear lines positioned to define a removable portion such that by removing the removable portion, the first end panel 370 may be bisected. The zipper 440 as a whole or the individual tear lines may be in the form of a number of slits or in any desired form or shape.

The first end panel 370 may have a pair of beveled edges 445 formed therein. The beveled edges 445 may accommodate the corner panels 281, 282 of the first part 110 and are designed to be disposed in general alignment with the respective beveled edges 316 of the corner panels 281, 282. As a result, the top panel 360 of the second part 120 thus may be largely rectangular in shape while the base panel 160 of the first part 110 may have a largely octagonal shape given the beveled edges 165.

The second end panel 380 may be hingedly connected to the top panel 360 via a second top panel fold line 460. The second end panel 380, when folded along the fold line 460, may take a position where it is largely parallel to the first end panel 370. The second end panel 380 may be largely identical to the first end panel 370 in shape. The second end panel 380 also may include a zipper 440 positioned therein and a pair of beveled edges 445.

The first and second side panels 390, 400 may be largely identical to each other. The first side panel 390 may be connected to the top panel 360 via a third top panel fold line 470 while the second side panel 400 may be connected to the top panel 360 via a fourth top panel fold line 480. Folding the four (4) panels 370, 380, 390, 400 about the four (4) top panel fold lines 410, 460, 470, 480, may form the second part or lid 120. The second part or lid 120 then may be attached to the first part or tray 110.

In use, the first part 110 may be erected by folding the side panels 190, 200 about the third and fourth base panel fold lines 270, 280. The first part 110 then may be filled with one or more articles, in this case a number of beverage containers 500 in the form of bottles. Any type of article, however, may be used. The flaps 330 on the side panels 190, 200 may be folded inward along the fold lines 335. The corner panels 282, 281 and the reinforcing panels 290, 300 then may be folded about the fold lines 283, 315, 310, 316. An adhesive then may be applied to the reinforcing panels 290, 300 and/or to the end panels 170, 180. The end panel 170, 180 then may be folded about the first and second base panel fold lines 210, 260 and attached to the reinforcing panels 290, 300 by means of the adhesive.

The second part orb lid 120 then may be attached to the first part or tray 110. Specifically, the side panels 390, 400 may be folded inward before the attachment. The second part 120 may be placed on top of the first part 110 such that the side panels 390, 400 are brought into face-contacting relationship with the flaps 330 of the first part 110 respectively. An adhesive may then be applied to the end panels 170, 180 of the first part 110. Preferably, the adhesive will be applied below the handle aperture 220 such that the end panels 170, 180 may be attached to the end panels 370, 380 at the portions below the zippers 440. The end panels 370, 380 of the second part 120 then may be folded downward along the fold lines 410, 460 and attached to the end panels 170, 180 of the first part 110. An end of the zipper 440 preferably aligns with the zipper cutout 250. Likewise, the handle apertures and cutouts 220, 320, 420 preferably align one another and form a single slot handle 520. An example of an assembled carton 100 is shown in FIG. 3.

The carton 100 as described herein thus may be constructed and filled on a straight-line carton machine. By the term “straight-line” machine, we mean that the first part 110 and the second part 120 of the carton 100 need not be rotated for the purposes of filling or for placing adhesives thereon. The straight-line machine can be used because the adhesives are only applied to the end panels 170, 180 of the first part 110 and/or the reinforcing panels 290, 300 of the first part 110. No adhesive thus need be applied to the side panels 190, 200 of the first part 110 or the side panels 390, 400 of the second part 120. Rather, the intersection of the flaps 330 of the first part 110 and the side panels 390, 400 of the second part 120 provides rigidity along the respective side panels 190, 200, 390, 400. Stated differently, the flaps 330, 330 of the tray 110 are not secured to the side panels 390, 400 of the lid 120 in the assembled carton 100. However, each flap 330 and the associated side panel 390 or 400 mate with each other in face-contacting relationship to form a reinforcing beam extending entirely along the adjacent upper side edge (335) of the carton. The beams enhance the rigidity of the carton such that the end panels 170, 370, top panel 360 and side panels 190 and 200 are prevented from being overly warped or otherwise deformed when the carton is lifted by the handle 520. The carton 100, with the beverage containers 500 in the form of bottles therein, may be lifted and carried by the handle 520. As is described above, the handle 520 may include three (3) reinforcing layers for strength.

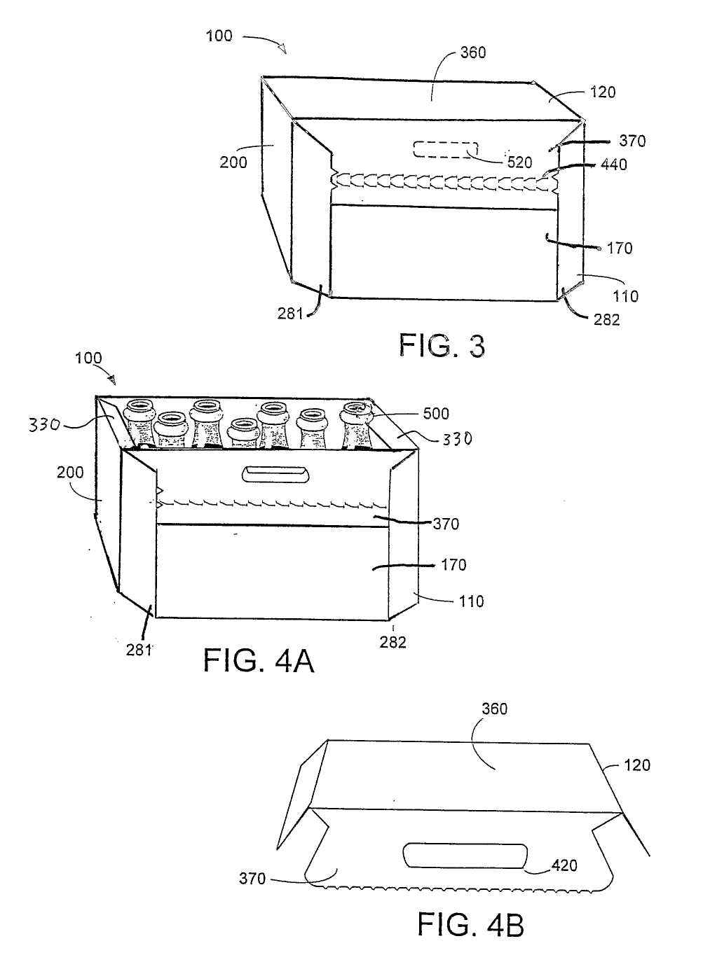

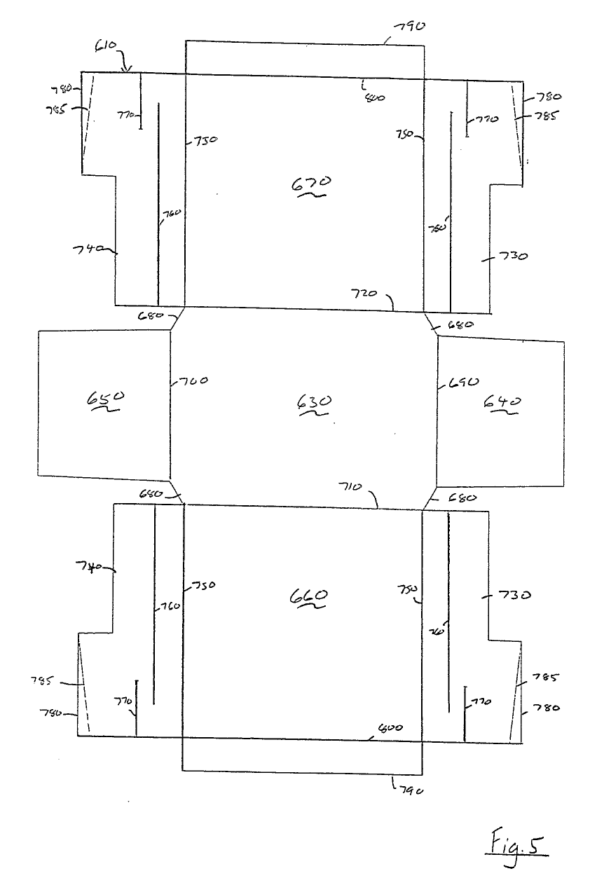

FIGS. 4A and 4B show the carton 100 with the second part or lid 120 removed. As is shown, the second part 120 may be removed or displaced by pulling the zippers 440 on the first and/or second end panels 370, 380. Removal of at least one of the zippers 440 allows the first and/or second end panel 370, 380 of the second part 120 to be removed from the first and/or second end panel 170, 180 of the first part 110. The portion or portions of the first end panel 370 and/or second end panel 380 below the zippers 440 may remain attached to the first part 110. The second part 120 is then removed, either partially or completely, from the first part 110.

The beverage containers 500 then may be removed from the first part or tray 110 as desired. Likewise, the first part or tray 110 also may be carried by the handle 520 with all or some of the beverage containers 500 remaining therein. Further, the first part 110 also may serve to return the empty beverage containers 500 or other articles as is desired.

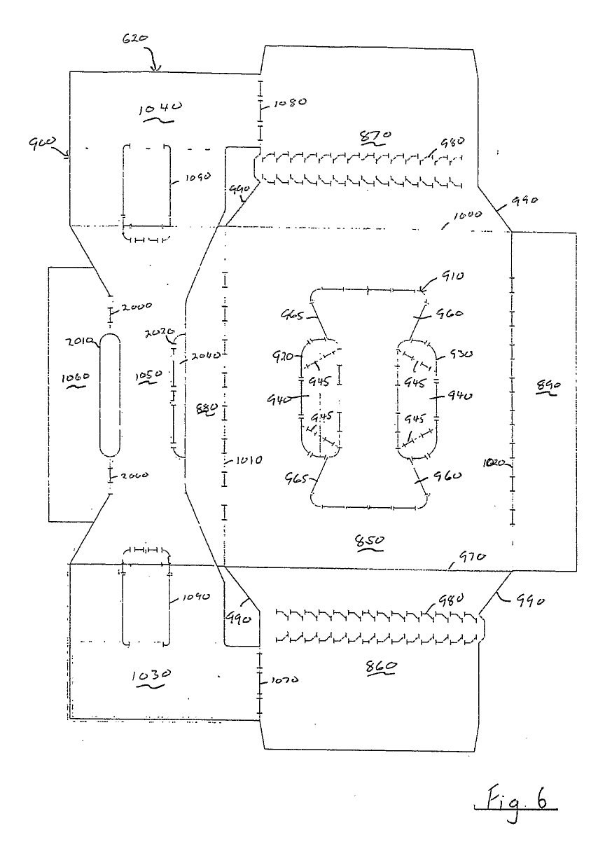

FIGS. 5-7 show a second embodiment of a carton 600 according to the invention. The carton 600 may be a two (2)-piece container with a first part 610 and a second part 620. The first part 610 may be a tray or a similar type of open basket structure and the second part 620 may be a lid or a similar type of covering structure and/or support structure.

FIG. 5 shows a blank that may be used to assemble the first part or tray 610. As described above, the fold lines may define a number of panels. Specifically, a base panel 630, a first end panel 640, a second end panel 650, a first side panel 660, a second side panel 670, as well as a number of corner panels as will be described in more detail below. The number of panels may be varied. Each of the panels may be largely rectangular in shape. Any desired size or shape, however, may be used.

The base panel 630 may have a number of beveled edges 680 such that the base panel 630 as a whole may have a largely octagonal shape. The first end panel 640 may be connected to the base panel 630 via a first base panel fold line 690. Likewise, the second end panel 650 may be connected to the base panel 630 via a second base panel fold line 700. The end panels 640, 650 may be largely identical in shape. When folded, the first end panel 640 and the second end panel 650 may be largely parallel to each other.

The first side panel 660 may be connected to base panel 630 via a third base panel fold line 710 and the second side panel 670 may be connected to the base panel 630 via a fourth base panel fold line 720. The side panels 660, 670 may be largely identical to each other. When folded, the side panels 660, 670 also may be largely parallel to each other and largely perpendicular to the end panels 640, 650.

The first and second side panels 660, 670 also each may be connected to a pair of corner panels. Specifically, a first corner panel 730 and a second corner panel 740. The corner panels 730, 740 may be hingedly connected to the respective side panel by corner panel fold lines 750. The corner panel fold lines 750 may run the vertical length of the corner panels 730, 740. Further, the corner panels 730, 740 each may have a pair of offset lines. Specifically, an offset fold line 760 and an offset cut line 770. The offset fold line 760 may run from the lower end of the respective corner panel 730 or 740 through most of the vertical length of the panel as is shown. The offset cut line 770 may start from the upper end of the respective corner panel 730 or 740 and extend shortly beyond the termination point of the adjacent offset fold line 760. The offset fold line 760 may accommodate the beveled edges 680 of the base panel 630. The corner panels 730, 740 as a whole each have a largely step-like shape with an upper corner panel tab 780. Each corner panel 730, 740 also may have an angled fold line 785 bordering the upper corner panel tab 780.

The first and second side panels 660, 670 further each may have a side panel flap 790 positioned thereon. The flaps 790 may extend entirely along the upper edges of the side panels 660, 670 and hingedly connected thereto along fold lines 800 respectively.

To form the first part 610, the side end panels 640, 650, 660, 670 may be folded along the four base panel fold lines 690, 700, 710, 720. Likewise, the corner panels 730, 740 may be folded along the corner panel fold lines 750, 760 such that a portion of the corner panels 730, 740 are positioned behind of or in front of the end panels 640, 650. The corner panels 730, 740 may be attached to either the inside or outside surfaces of the end panels 640, 650 respectively by adhesive or other conventional securing means such as staples are mechanical locks.

FIG. 6 shows a blank for the second part or lid 620. As above, the fold lines may define a number of panels. In this example, a top panel 850, a first end panel 860, a second end panel 870, a first side panel 880, a second side panel 890, and a handle panel 900. The number of panels may be varied. Each of the panels may be largely rectangular in shape. Any desired size or shape, however, may be used.

The top panel 850 may have a saddle handle cover panel 910 defined therein. The handle cover panel 910 may be partially defined by a pair of handle apertures formed in the top panel 850. The first and second handle apertures 920, 930 are located on the opposite sides of the handle cover panel 910. The handle apertures 920, 930 may have a largely extended oval shape. The handle apertures 920, 930 each may define a handle flap 940. The respective handle flaps 940 may be folded inwardly of the carton for reinforcement as well as to enhance comfort of user's hand. Each handle flap 940 also may have a number of diagonal tear lines 945 positioned therein so as to form the handle flap 940 in a substantial cone shape. The handle apertures 920, 930 may be adjoined on either end by an extension portion 960. The extension portions 960 may be defined by extension tear lines 965 so that the handle cover panel 910 may be severed, together with the handle flaps 920, 930, from the top panel 850 and may be raised above the top panel 850.

The first end panel 860 may be hingedly connected to the top panel 850 via a first top panel fold line 970. The first end panel 860 also may have a zipper 980 formed therein. The first end panel 860 also may have a pair of beveled edges 990 positioned adjacent to the top panel 850. The beveled edges 990 may accommodate the corner panels 730, 740 of the first part 610. The beveled edges 990 thus permit the base panel 630 of the first part 610 to be largely octagonal in shape while the top panel 850 of the second part 620 may be largely rectangular in shape.

The second end panel 870 may be hingedly connected to the top panel 850 via a second base panel fold line 1000. The second end panel 870 also may include a zipper 980 positioned therein as well as a pair of the beveled edges 990. The second end panel 870, when folded, may be largely parallel to the first end panel 860. The second end panel 870 may be largely identical in shape to the first end panel 860.

The first side panel 880 may be hingedly connected to the top panel 850 via a third top panel fold line 1010. The first side panel 880 may be largely trapezoidal in shape. The second side panel 890 may be hingedly connected to the top panel 850 via a fourth top panel fold line 1020. The second side panel 890 may be substantially rectangular in shape. Any convenient size or shape, however, may be used.

The handle panel 900 may be connected to the first and second end panels 860, 870. The handle panel 900 may have a first handle end panel 1030, a second handle end panel 1040, a handle base panel 1050, and a handle reinforcement panel 1060. The handle end panels 1030, 1040 may be largely rectangular in shape and may be connected to their respective first and second end panels 860, 870 via first and second handle panel fold lines 1070, 1080. The handle end panels 1030, 1040 each may have an yielding tab 1090 formed therein. Any convenient size or shape may be used for the yielding tab 1090. The yielding tab 1090 may extend into the handle base panel 1050.

The handle reinforcement panel 1060 may be connected to the handle base panel 1050 via a third handle panel fold line 2000. The handle reinforcement panel 1060 may fold along the third handle panel fold line 2000 to place itself underneath the handle base panel 1050. The handle base panel 1050 and the handle reinforcement panel 1060 may define a handle cutout 2010. The handle cutout 2010 may have an extended oval shape. Further, the handle base panel 1050 also may define another handle cutout 2020. The handle cutout 2020 may have an extended half-oval shape. The handle cutout 2020 defines a handle flap 2040. The handle flap 2040 may be folded underneath handle base panel 1050. The handle base panel 1050 may have a width between the handle cutouts 2010, 2020 of about the same dimension as the width between the handle apertures 920, 930 of the top panel 850.

To construct the second part 620, an adhesive may be attached to the first and second handle end panels 1030, 1040 and/or the first and second end panels 860, 870. The adhesive may be applied such that when the first and the second handle end panels 1030, 1040 are folded 180 degrees along the fold lines 1070, 1080, they may be attached to the inside surfaces of the first and second end panels 860, 870 below the zipper 980. Likewise, the handle reinforcing panel 1060 may be attached by glue or other types of adhesives to the handle base panel 1050 by folding the reinforcing panel 1060 about the handle panel fold line 2000. When folded, the handle cutouts 2010, 2020 of the handle base panel 1050 may align with the first and second handle apertures 920, 930 of the top panel 850. The first and second end panels 860, 870 then may be folded about 90 degrees downward as well as the second side panels 880, 890.

As described above, the first part 610 may be erected by folding the side panels 660, 670 about the based panel fold lines 710, 720. The first part 610 then may be filed with one or more articles, such as the beverage containers 500 in the form of bottles. Any type of article, however, may be used. The flaps 790 on the side panels, 660, 670 may be folded inward. The corner panels 730, 740 may then be folded about the corner panel fold line 750 and the offset fold line 760. An adhesive then may be applied to the corner panels 730, 740 or to the end panels 640, 650. The end panels 640, 650 then may be folded about the base panel fold lines 690, 700 and attached to the corner panels 730, 740 via the adhesive.

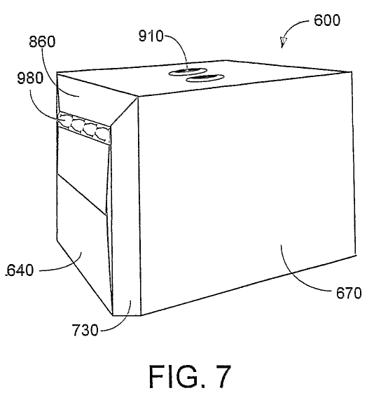

Likewise, the second part 620 may be constructed as described above. Specifically, the handle reinforcing panel 1060 of the handle panel 900 may be attached to the handle base panel 1050. The first and second handle end panels 1030, 1040 then may be attached to the first and second end panels 860, 870. The second part 620 may then be attached to the first part 620. Specifically, the side panels 880, 890 may be folded inward. The second part 620 may be placed on top of the first part 610 such that the side panels 880, 890 may be brought into face-contacting relationship with the flaps 790 of the first part 610. Each side panel of the second part and the associated flap 790 in cooperation form a rigidity-enhancing beam in a similar manner as in the foregoing embodiment. An adhesive then may be applied to the end panels 640, 650 of the first part 610. The end panels 860, 870 of the second part 620 then may be folded downward and attached to the end panels 640, 650 of the first part 610. An example of an assembled carton 600 is shown in FIG. 7.

As described above, the carton 600 thus may be constructed and filled on a straight-line carton machine. The straight-line machine can be used because the adhesives are only applied to the end panels 640, 650 of the first part 610 and/or the corner panels 730, 740 of the first part 610. No adhesive thus need be applied to the side panels 660, 670 of the first part 610 or the side panels 880, 890 of the second part 620. Rather, the beams provided by the flaps 790 and the side panels 880, 890 enhance the rigidity along the side panels 660, 670, top panel 850 and end panels 860, 870. Moreover, the handle panel 900 is affixed to the end panels 640, 650 for further stability.

The carton 600 with the beverage containers 500 therein, in this case in the form of bottles, may be carried via the handle 900. As is described above, the handle 900 may include three (3) reinforcing layers for strength.

The second part 620 may be removed by pulling the zippers 980 on the first and second end panels 860, 870. Removal of the zippers 980 allows the top panel 850 and parts of the end panels 860, 870 of the second part 620 to be removed from the end panels 640, 650 of the first part 610. The portion of the end panels 860, 870 of the second part 620 below the zippers 980 may remain attached to the first part 610. Likewise, the handle panel 900 of the second part 620 may remain attached via the first and second end panels 630, 640. The handle panel 900 may remain such that the carton 600 may be carried once the second part 620 is removed as is described above.

It should be understood that the foregoing relates only to the exemplary embodiments of the present invention and that numerous changes and modifications may be made herein without departing from the general spirit and scope of the invention as defined by the following claims and the equivalents thereof.

1. A carton, comprising:
a tray including a pair of tray side panels and a pair of tray end panels; and
a lid including a pair of lid side panels and a pair of lid end panels, said tray end panels comprising adhesive thereon such that said lid end panels are attached to said tray end panels while said lid side panels are disposed adjacent to but remain unsecured to said tray side panels.

2. The carton of claim 1, wherein a first one of said tray end panels comprises a tray handle aperture and wherein a first one of said lid end panels comprises a lid handle aperture.

3. The carton of claim 1, wherein said tray comprises a tray base panel and said lid comprises a lid top panel.

4. The carton of claim 3, wherein said lid top panel comprises at least one lid handle aperture defined therein.

5. The carton of claim 4, wherein said lid top panel comprises a saddle handle cover panel.

6. The carton of claim 3, wherein said tray base panel is generally octagonal in shape.

7. The carton of claim 6, wherein said lid top panel is generally rectangular in shape.

8. The carton of claim 7, wherein each of said tray side panels are connected to a pair of beveled corner panels.

9. The carton of claim 8, wherein each of said lid end panels comprises a pair of beveled edges.

10. The carton of claim 1, wherein each of said lid end panels comprises a zipper.

11. The carton of claim 1, wherein said tray comprises a pair of reinforcing panels connected to said tray side panels.

12. The carton of claim 1, wherein tray comprises a pair of tray flaps connected to said tray side panels.

13. The carton of claim 12, wherein when said lid is placed on said tray, said tray flaps are positioned adjacent to said lid side panels but not attached thereto.

14. The carton of claim 1, wherein said lid comprises a handle panel.

15. The carton of claim 1, wherein said lid to panel extends between said lid side panels.

16. A carton, comprising:
a tray including an end panel, a first reinforcing panel, and a second reinforcing panel;
said end panel comprises a first handle aperture;
said first reinforcing panel comprises a first handle cutout and said second reinforcing panel comprises a second handle cutout, said first and said second reinforcing panels are disposed along one of opposite surfaces of said end panel such that said first and second handle cutouts are aligned with each other to form a second handle aperture that in turn is aligned with said first handle aperture; and
a lid including a lid end panel with a third handle aperture, wherein said lid is attached to said tray such that said lid end panel is disposed on one of opposite surfaces of said end panel of said tray, and wherein said third handle aperture is aligned with said first and said second handle apertures.

17. The carton of claim 16, wherein said lid end panel comprises a zipper cutout.

18. The carton of claim 16, wherein said tray further comprises a pair of tray side panels and wherein each of said tray side panels comprises a flap connected thereto.

19. The carton of claim 18, wherein said lid further comprises a pair of lid side panels such that when said lid is positioned on said tray, said side panel flaps are positioned adjacent to but not attached to said lid side panels.

20. The carton of claim 16, wherein said lid end panel comprises a zipper thereon.

21. The carton of claim 20, wherein said lid end panel is fixedly attached to said tray about said zipper.

22. A carton, comprising:
a first part; and
a removable second part,
said first part comprises a first panel with a first handle aperture and a reinforcing panel with a first handle cutout, said second part comprises a second panel with a second handle aperture such that when said second part is attached to said first part, and said second handle aperture is aligned with said first handle aperture and said first handle cutout.

23. The carton of claim 22, wherein said second panel of said second part comprises a zipper thereon and wherein said second part is attached to said first part about said zipper.

24. A carton, comprising:
a first part including a pair of first side panels and a pair of first end panels; and
a second part including a pair of second side panels, a pair of second end panels, and a handle aperture; and
said pair of first end panels comprising adhesive thereon so as to be secured to said second end panels, and said first side panels are positioned adjacent to, but not attached to, said second side panels.

25. The carton of claim 24, wherein said second part comprises a handle panel fixedly attached to said first part by said adhesive.

26. A method of constructing a carton with a tray and a lid, comprising:
folding a tray blank such that a first panel with a first handle aperture is positioned adjacent to a pair of reinforcing panels with a handle cutout;
fixedly attaching the first panel to the reinforcing panel to form the tray;
folding a lid blank with a first lid panel with a second handle aperture and a zipper to form the lid;
positioning the lid on the tray such that the second handle aperture aligns with the first handle aperture and the handle cutouts; and
fixedly attaching the lid to the tray about the zipper.
